(19) United States
(12) Patent Application Publication
(10) Pub. No.: US 2024/0264326 A1
(43) Pub. Date: Aug. 8, 2024

(54) Magnetic Stud Finding and Laser Marking Device

(71) Applicant: Ellis Junior Smith, Belmont, NC (US)

(72) Inventor: Ellis Junior Smith, Belmont, NC (US)

(21) Appl. No.: 18/422,218

(22) Filed: Jan. 25, 2024

Related U.S. Application Data
(60) Provisional application No. 63/444,042, filed on Feb. 8, 2023.

(51) Int. Cl. G01V 3/08; G01C 9/34; G01C 15/00; G01V 3/165

(52) U.S. Cl. CPC G01V 3/081; G01C 9/34; G01C 15/004; G01V 3/165

(57) ABSTRACT

A stud finding apparatus is described comprising of an improved magnetic mounting configuration that enables the stud finding device to be used in unique ways that improve the overall functionality and performance of the stud finder device and enables the device to perform the functions of several common tools, provides a new method to locate the exact center of studs and the exact center of fasteners much more quickly and accurately, and provides the ability to firmly mount the device to the wall even while including the weight of additional features such as electronic functionality, an adjustable laser, and an integrated distance finder.

### CROSS-REFERENCE TO RELATED APPLICATIONS

This application claims priority of U.S. Provisional Patent Application Ser. No. 63/444,042 filed on Feb. 8, 2023 and incorporated herein by reference.

### BACKGROUND OF THE INVENTION

A stud finding apparatus is described comprising of an improved magnetic mounting configuration that enables the stud finding device to be used in unique ways that improve the overall functionality and performance of the stud finder device and enables the device to perform the functions of several common tools, provides a new method to locate the exact center of studs and the exact center of fasteners much more quickly and accurately, and provides the ability to firmly mount the device to a construction surface of any orientation even while including the weight of additional features such as electronic stud finding functionality, an adjustable laser, and an integrated distance finder.

More specifically, the present invention relates to a stud finding device typically used in residential or commercial construction to locate studs, joists, fasteners, or other structural framing members generally located inside of walls, ceilings, or floor construction and is also used to create measurements and to provide working reference lines on the walls to assist with construction activities such as hanging pictures, curtains, television mounts, etc. The present invention also relates to laser line marking devices, chalk line marking devices, distance measurement devices, and tripods that are typically used to position laser line marking devices.

One existing magnetic stud finding device utilizes a single magnet to locate a fastener such as a drywall nail or screw. Similar magnetic stud-finding devices sometimes utilize multiple magnets, typically separated by a distance, to improve the odds of locating a nail with fewer hand motions and less time. The user of these devices can typically feel the magnetic attraction of the device to the metallic wall fastener as the magnet is swept across the wall and crosses over the top of a fastener such as a drywall fastener.

Magnetic stud finders are typically reliable in finding nails or screws, and do not typically require electronic systems or batteries. These devices are easy to use, very low cost to manufacture, low maintenance, durable and tend to easily fit into someone's toolbox or pocket.

Even with multiple independent magnets, magnetic stud finders are slow to locate a fastener since the size of the magnets are typically small and the device must be swiped across the wall dozens of times to locate a target fastener.

One problem with magnetic stud finders is that they are less accurate at locating the exact center or the edges of the studs since the magnetic wall fasteners may not be in the exact center of the stud versus electronic stud finders. A remedy for this problem is to locate several fasteners on the stud and to estimate the center of all the fasteners to improve the overall accuracy.

One additional issue with magnetic stud finding devices is that the magnets are typically individual magnets that tend to have a high field density and attractive force around the perimeter of the individual magnets and therefore the drywall screw tends to be attracted to a location on the magnet that is off-center from the device thereby reducing the accuracy of locating the exact center of the fastener. Also, individual magnets tend to not have enough strength to locate screws through surfaces that have thick layers of paint or to locate drywall screws that are sunk deep into the surface. Larger individual magnets may be used; however, the overall weight of the larger magnet may exceed the attractive force to the screw and the device may not remain attached due to gravity.

An electronic style stud finding device that utilizes a differential capacitive sensor measures a change in capacitance as the device is swept laterally. This style of sensor quickly determines locations at which a significant change in density or capacitance occurs in the wall by swiping the device laterally across a wall. These electronic devices typically also include a sensor for locating electrical wires and other objects inside of the walls. In many cases, these types of electronic sensors may give false readings of the stud location, and it is desirable to either re-calibrate and re-sweep the wall several times to confirm that a target stud is found or and there is a need to further confirm the stud location with a magnetic stud finder and locate several drywall screws magnetically to increase the overall confidence of locating a stud.

Other electronic stud finding devices utilize sound waves, radar waves, and other wave-based or frequency-based technologies in the task of locating various objects found in the walls. These electronic detection devices are typically limited to specific construction materials and these devices are typically expensive and are more complex to maintain and use.

It is sometimes desirable to provide marks or construction lines on the construction surfaces while construction activities, such as mounting drywall, are underway. Current devices that provide construction marks on the working surface include chalk lines, laser lines, or pencil marks.

Laser marking lines typically require the use of a laser line generator mounted to a tripod to position the laser at the correct height. Tripods are typically too large to fit into a toolbox and are usually too short to hold the laser at the height required to mount common items such as pictures, curtains or other objects that are typically located higher on the walls and mounted at or above a person's eye level. In many cases, the tripods must sit on tables or furniture to achieve the desired height. In many cases, tripods are too large to fit into small spaces such as bathrooms.

Laser marking devices may also be temporarily fastened to a work surface with tape, nails, tacks, screws, or other fasteners that may damage the construction surface and these mounting techniques tend to not be reliable and they are time consuming.

It is desirable to temporarily mark construction surfaces with a horizontal (elevation) or vertical (plumb) laser lines to either mark studs, mark fastener locations, mark locations of items in the wall such as studs, nails, screws, wiring, etc. or to mount objects such as pictures or television mounts. Elevation laser lines are typically created with self-leveling devices that require a tripod or external mount to raise the device to the required height such as a tripod.

Current Lasers that “auto level” or “auto plumb” and utilize a gravity operated “plumb bob” style mechanism are incapable of projecting elevation laser lines at any height due to the limitation of needing a tripod or some other type of mount to raise the device to the needed elevation. Most tripods are too short to hold the laser levels at the height required to hang pictures or television mounts usually above eye level. Large tripods will not fit in a typical toolbox.

The stud finding and laser marking device in accordance with the present invention may be capable of spinning about the center of a nail to enable projection of the laser lines in any direction without concern that the device has moved off-center from the drywall screw.

The stud finding and laser marking device in accordance with the present invention may provide a vertical plumb mark on a stud while the device is mounted to the center of a nail, and/or project laser lines around a room at any height position or horizontal position without the need for a tripod or separate mounting device.

The stud finding and laser marking device in accordance with the present invention may be capable of spinning about the center of a nail to enable projection of the laser lines in any direction.

The stud finding and laser marking device in accordance with the present invention may be capable of mounting on a surface without the need for tape, tacks, or other fastening methods.

The stud finding and laser marking device in accordance with the present invention may remain on the wall without moving while construction activities are performed.

The stud finding and laser marking device in accordance with the present invention may easily locate neighboring studs without the need for an additional tape measure and thus may reduce the number of tools needed to locate and mark a stud.

The stud finding and laser marking device in accordance with the present invention may minimize the number of tools needed to locate studs, mark studs, and project construction lines, including, for example, tools such as squares, levels, tape measures and tripods.

### SUMMARY OF THE INVENTION

Preferred embodiments of the present invention include a laser marking device having a housing with a top, bottom, and side walls, the bottom wall having a substantially planar bottom surface, a pair of dipole magnets forming a compound pair of magnets disposed in the bottom surface, a barrel having a proximal end and a distal end, the barrel pivotally mounted near its proximal end to the device housing for pivotal movement in relation to the housing, and a laser disposed within the barrel, the laser creating, when activated, a laser beam projecting through the distal end of the barrel.

The compound pair of magnets of preferred embodiments of the present invention may have a first side disposed in the bottom surface and a second side opposite the first side. A metal plate may be disposed at the second side of the compound pair of magnets. The compound pair of magnets may also have 4 additional sides perpendicular to one another.

Preferred embodiments of the present invention may further include a stop disposed in the device housing positioned to stop the pivoting of the barrel at a predefined position such that when activated, the laser beam intersects a plane defined by the planar bottom surface. Also, the laser beam may intersect the plane defined by the planar bottom surface at a predetermined distance from the housing, which may be between 15 and 17 inches from the center of the magnet.

In any of the foregoing embodiments the laser beam may be a cross beam and may have a differential capacitive sensor for stud edge detection.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

### BRIEF DESCRIPTION OF DRAWINGS

The objects and features of the invention may be understood with reference to the following detailed description of an illustrative embodiment of the present invention taken together in conjunction with the accompanying drawings in which:

FIG. 1 is a first perspective view of an embodiment of the present invention.

FIG. 2 is a second perspective view of an embodiment of the present invention.

FIG. 3 is a third perspective view of an embodiment of the present invention.

FIG. 4 is a fourth perspective view of an embodiment of the present invention.

FIG. 5 is a first elevation view of an embodiment of the present invention.

FIG. 6 is a second elevation view of an embodiment of the present invention.

FIG. 7a is a top view of an embodiment of the present invention with led indicator lights shown disposed into the top surface.

FIG. 7b is a top view of an embodiment of the present invention illustrating a digital display disposed into the housing disposed into the top surface.

FIG. 8 is a bottom view of an embodiment of the present invention.

FIG. 9a is a front view of an embodiment of the present invention.

FIG. 9b is a front view of an embodiment of the present invention illustrating an optical distance sensor disposed into the housing.

FIG. 10 is a back (rear) view of an embodiment of the present invention.

FIG. 11 is a sectional view of an embodiment of the present invention with the cutting plane 11-11 illustrated in FIG. 7.

FIG. 12 is a sectional view of an embodiment of the present invention with the cutting plane 12-12 illustrated in FIG. 7.

FIG. 13 is an exploded view of an embodiment of the present invention.

FIG. 14 is an exploded view of subassembly 14 illustrated in FIG. 13.

FIG. 15 is a view of an embodiment of the present invention in use.

FIG. 16 is a second view of an embodiment of the present invention in use.

FIG. 17 is a prior art exploded view of a prior art embodiment of a conventional magnetic stud finder with multiple magnets and spirit levels.

FIG. 18 is a top view of a prior art embodiment shown in use.

FIG. 19 is a perspective view of a prior art embodiment.

FIG. 20 is a prior art method of scanning for a drywall screw with a magnetic stud finder.

FIG. 21a is a detail of a pair of dipole magnets forming a compound pair of magnets in accordance with a preferred embodiment of the present invention.

FIG. 21b is a detail of stacked pairs of dipole magnets forming stacked compound pairs of magnets in accordance with a preferred embodiment of the present invention.

FIG. 22 is the bottom view of the assembly illustrated in FIG. 21.

FIG. 23 is a perspective view of a preferred embodiment of the present invention.

FIG. 24 is a method of use of a preferred embodiment of the present invention.

FIG. 25 is a view of use of a preferred embodiment of the present invention.

FIG. 26 is an additional detailed view of the device illustrated in FIG. 25 that is the position of the laser barrel and the bubble levels.

FIG. 27 is an additional view of a preferred embodiment of the present invention in use.

FIG. 28 is a detail of FIG. 27.

FIG. 29 is an additional view of a preferred embodiment of the present invention in use.

FIG. 30 is a detail of FIG. 29.

FIG. 31 is an additional view of a preferred embodiment of the present invention in use.

FIG. 32 is a detail of FIG. 31.

FIG. 33 is a perspective view of an alternate embodiment of present invention.

### DETAILED DESCRIPTION OF THE INVENTION

As used herein and unless context requires otherwise, the following terms have the following meanings in addition to the usual and ordinary meanings in the art, to the extent that such usual and ordinary meanings are not inconsistent with the meanings provided herein.

The terms “individual” and “user” refer to an entity, e.g., a human, using an article of manufacture providing a magnetic laser stud finder according to the present invention. The term “user” herein refers to one or more users.

The term “stud finder” refers to a device typically used to locate framing members such as studs or joists within a wall, ceiling, or floor joist or any other framing member typically found in residential or commercial building construction. When combined with appropriate laser marking and/or leveling structures, this device may serve multiple secondary functions such as projecting laser lines, performing leveling operations, performing squaring operations or angular measurements, locating live wires, and performing linear measurements.

The term “screw finder” is an alternate term describing a magnetic stud finder.

The term “plumb” generally refers to the vertical direction relative to the floor of a room. Studs are generally mounted vertically and may be temporarily marked with plumb laser lines or plumb laser lines.

The term “elevation” generally refers to the horizontal direction relative to the floor of a room. A projected laser elevation line may be used generally for purposes such as positioning and leveling pictures or other objects to make them parallel to the floor and at a given height from the floor.

The term “magnetic field” refers to a field produced by a magnet that ultimately produces a magnetic reaction force against another object.

The terms “laser line”, “laser beam”, or “beam” refers to a line produced by a laser such as a diode used in construction to produce various marks used to perform construction tasks. Laser patterns may include a dot (“dot laser”), a line (“line laser”), and a cross (“cross laser”).

The terms “drywall screw”, “nail”, or “screw” refers to any fastener used to restrain objects such as a sheet of wallboard to framing members such as studs and can be used as a target to locate the same studs or joists.

The term “corner edging” refers to a metallic corner edging found in drywall construction and used mainly on external corners of a wall structure.

The term “charging port” refers to a battery charging port to provide for a battery to be recharged without removing the battery from a device such as a stud finding apparatus in accordance with the present invention.

The term “laser barrel” refers to a hollow cylindrical shell portion of the pivoting laser module that may contain a laser such as a laser diode. The laser barrel may include a pivot that is oriented in a perpendicular direction to the axis of the laser barrel used to orient the laser barrel into a desired angular position relative to a main housing.

The term “main housing” refers to a frame structure of the device that generally positions and constrains the primary fixed and moving components of the device.

The term “holding force” refers to a magnetic attractive force between a magnet and any corresponding magnetic object.

The term “magnetic field center” refers to a region on a magnetic interface that has the highest magnetic field strength and highest attractive force to a metallic object.

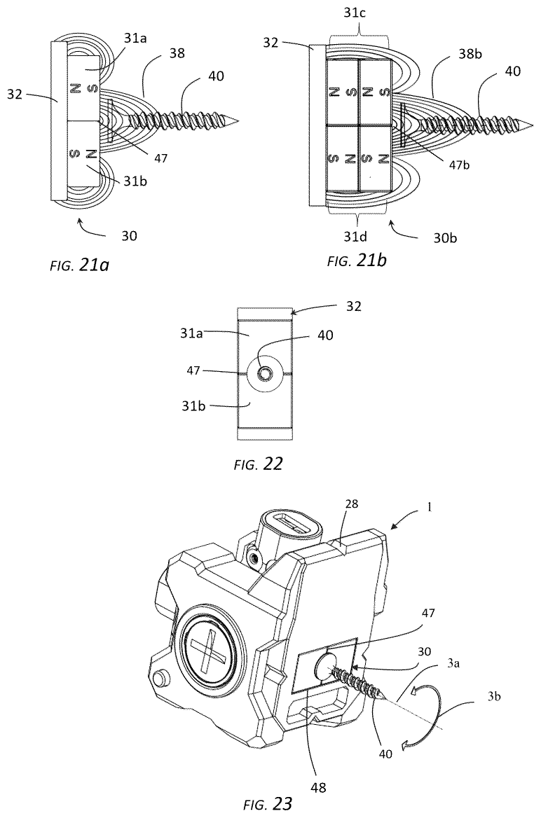

The term “compound pair of magnets” means a pair of magnets functionally coupled as shown in FIG. 21a and also as shown in a stacked arrangement in FIG. 21b.

The term “marking surface” refers to a surface that is generally perpendicular to a contact surface of a tool used to facilitate a marking device such as a pencil to create a line or mark on the working surface. A “marking surface” may have marking guides to position a line or mark at a predetermined location.

The term “working surface” refers to any construction surface such as a drywall ceiling or wall surface.

The term “contact surface” refers to a side of the tool that is in direct contact with the working surface.

The term “differential capacitive sensor” refers to a capacitor plate sometimes mounted adjacent to a housing flat bottom surface typically with a circuit for detecting any change in the capacitance of a capacitor plate due to a change in the dielectric constant of the wall as the stud finder is moved across the wall.

Referring to the figures, preferred embodiments of the present invention will now be discussed, with like numbers in the various figures referring to the same or similar elements.

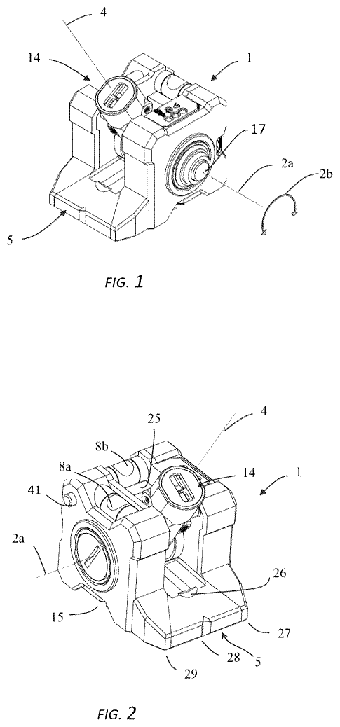

As shown in FIG. 1, a preferred embodiment of the present invention includes stud finding device (1) includes a main housing assembly (5) with the pivoting laser module (14) pivoting on housing axis (2a) through a range of motion (2b) and a laser beam directional axis (4). A laser activation toggle button (17) may be mounted in the pivoting laser module (14) on axis (2a).

With reference to FIG. 2, a pivoting laser module (14) may pivot on axis (2a) with an upward mechanical stop (in this case, a stop surface) (25) located on the main housing assembly (5) that positions the pivoting laser module perpendicular to the magnetic base mounting surface (15). This upward position of the pivoting laser module might be used to transfer a mark to an opposing surface. A lower mechanical stop surface (26) is shown that positions the pivoting laser module (14) in a lower position that could be used for tasks such as project a laser line along axis (4) at a specified distance or to project a laser line horizontally. Bubble level (8b) is mounted generally parallel with laser module pivoting axis (2a) and bubble level (8a) is mounted generally perpendicular to laser module pivoting axis (2a). Button (41) is generally used to control the electronic stud edge finding system. The main housing has an indicator notch (28) used to mark the center of a stud or other object, indicator mark (27) & indicator mark (28) might be used to mark the edges of a stud or other object.

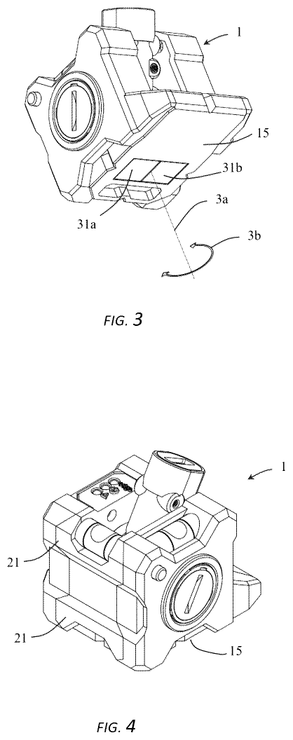

FIG. 3 illustrates an isometric view of a preferred embodiment of the present invention wherein the stud finding device has a generally flat base mounting surface (15) that may be used to contact a general construction surface such as a drywall surface or may be used to interface with an attachment that has a similar interface such as a belt clip or panel cutting attachment. Magnets (31a) and (31b) are shown to be generally flush with the base mounting surface (15). Screw axis (3a) is shown to be the axis that is formed by the magnetic attachment of the device (1) to a screw. The magnetic field produced by magnets (31a) and (31b) is localized and strongest at Axis (3a). Axis (3a) may be used to spin or rotate the entire device (1) about the axis (3a) to position the device as needed about the screw or nail.

Referring to FIG. 4, a preferred embodiment of the present invention is shown in an isometric view with back wall (21) that is perpendicular to the flat base mounting surface (15). This angular position may enable surface (21) to be used as a gauge to confirm that a corner is square on a construction frame.

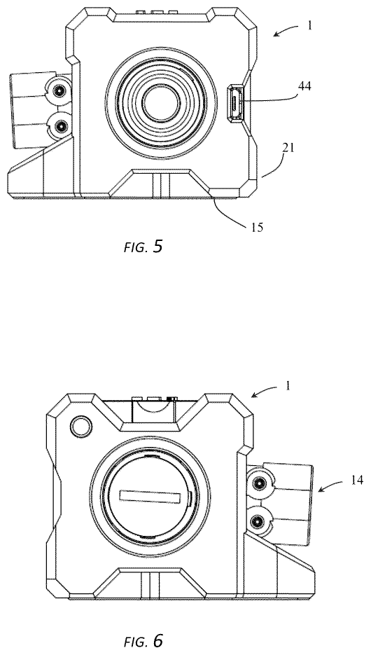

FIGS. 5 and 6 illustrate left and right hand views respectively of a preferred embodiment of the present invention back wall (21) that is perpendicular to the flat base mounting surface (15). This angular position may enable surface (21) to be used as a gauge to confirm that a corner is square on a construction frame. In these embodiments, laser module (14) is positioned in the downward position against a stop, allowing the laser to project a line at a fixed offset position such as 16 inches or 24 inches to enable quick marking of an adjacent stud.

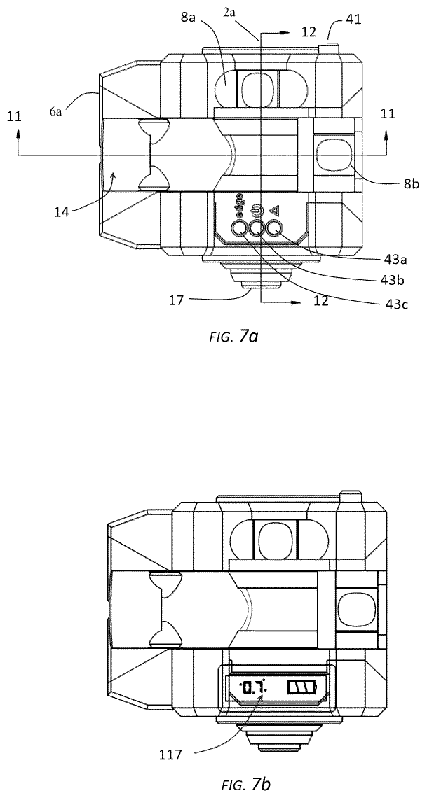

Referring now to FIG. 7a, a preferred embodiment of the present invention is shown wherein the main housing (6a) has a pivoting laser module (14) that pivots about axis (2a), bubble level (8a) generally mounted perpendicular to the laser module pivot axis (2a), bubble level (8b) generally mounted parallel to the laser module pivot axis (2a), indicator light (43a) that turns on when the device is active and near a live alternating current wire, indicator green light turns on when the edge finding circuit is activated (43b), and red indicator light (43c) that turns on when the edge finding circuit is initially calibrated, then turns off until the device senses a change in wall density and then turns back on indicating the edge of a stud has been located. The laser activation button (17) and edge finding system control button (41) are generally shown in ergonomic positions that enable activation of both buttons with a thumb to forefinger pinch action that does not cause the stud finder to accidentally move once magnetically mounted to a wall. This general layout of the bubble levels and display mounted on three sides around the pivoting laser module (14) provides a compact packaging of components with visibility to the bubble levels and display while the stud finder is being used and while the pivoting laser module is adjusted as needed.

Similarly, in FIG. 7b a preferred embodiment of the present invention is shown wherein the various indicator lights of FIG. 7a have been replaced with a digital display 117 showing information output from a processing circuit (not shown) contained within the device.

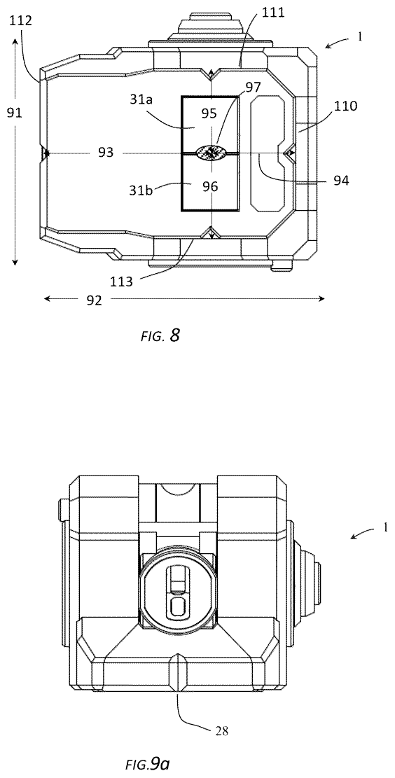

In FIG. 8, a preferred embodiment of the present invention is shown in a bottom view showing interface dimensions of alignment edges relative to the center of the magnetic field center (97). The magnetic field center (97) is shown in the central area between magnet (31a) and magnet (31b) and is the region of highest magnetic field strength and that magnetically locates the center of a drywall screw. Edges (110), (111), (112) and (113) are utilized for alignment of the device in a mating attachment or for creating reference pencil marks if needed to mark the edges of a stud. Dimension (91) may have a nominal value of 1.5+/−0.25 inches to match the width range of a standard stud. Dimension (92) may have a nominal value of 2.25+/−2 inches to match the standard thickness of a stud and a common 0.75-inch half thickness of a stud or common board thickness. Dimension (93) may have a nominal value of 1.5+/−0.5 inches. Dimension (94) may have a nominal value of 0.75+/−0.5 inches. Dimension (95) may have a nominal value of 0.75+/−0.5 inches. Dimensions (96) may have a nominal value of 0.75+/−0.5 inches.

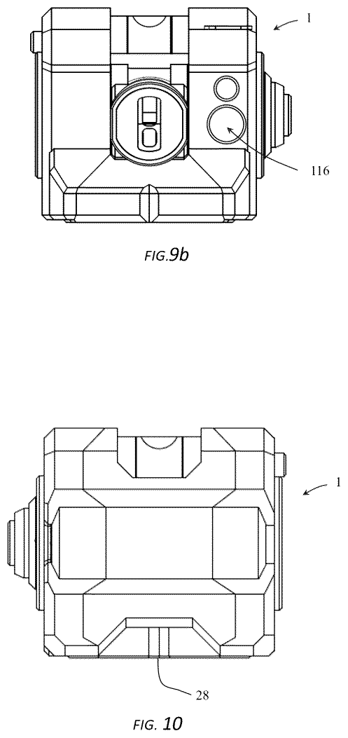

Referring now to FIG. 9a, a front view of the stud finding device (1) of a preferred embodiment of the present invention is shown including indicator notch 28 located in the middle of the device (1).

In FIG. 9b is shown a preferred embodiment of the present invention having an optical distance measurement sensor (116) consisting of a light emitting source and a light receiving device configured to receive light reflected by a target object. The optical sensing control circuit calculates distance based on the analysis of the transmitted, reflected and then received light beams and then displays that distance to the operator.

With reference to FIG. 10, a rear view of the stud finding device (1) of a preferred embodiment of the present invention is shown including indicator notch 28 located in the middle of the device (1).

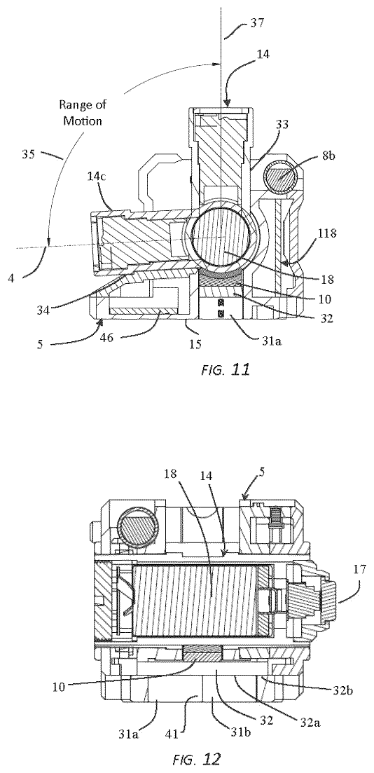

FIGS. 11 and 12 show cross sections of the device with the section lines (11) and (12), respectively, as shown in FIG. 7. A range of motion of the pivoting laser module is shown in FIG. 11. When the pivoting laser module (14) is in a downward position, the laser module barrel (14c) contacts surface (34) on the main housing (5) with axis (4) becoming the laser directional axis. In this position, the cross laser can project a plumb laser line along the neighboring stud at a standard distance such as 16 inches. The pivoting laser module (14) can be adjusted to the full upward position through the range of motion angle (35) until the laser module barrel (14c) contacts surface (33) of the main housing (5). In this position, the laser module barrel of the pivoting laser module is pointed straight upwards, and the axis (37) is directed normal to the mounting surface (15). In this position, the axis (37) is also aligned with the drywall screw axis if the device is mounted to a drywall screw. The cross sections also show a cylindrical battery (18) located inside of the pivoting laser module (14), a laser activation button (17), and a frictional brake (10) that acts to hold the pivoting laser module (14) in an adjusted position. The main electronic control board (118) is shown within the main housing along with the differential capacitive sensor (46) located parallel to the bottom contact surface of the device. Bubble level (8b) is shown located with an axis parallel to the pivoting axis of the pivoting laser module and parallel to the bottom surface (15) of the device. Magnets (31a) and (31b) are magnetically attached to one another at surface (41). A metallic backing plate (32) is magnetically attached to magnets (31a) and (31b) at surface (32a). The metallic backing plate (32) is constrained in housing assembly (5) at surface (32b) to prevent the magnets from being pulled out of the housing assembly (5) when being unattached from a wall or other metallic surface.

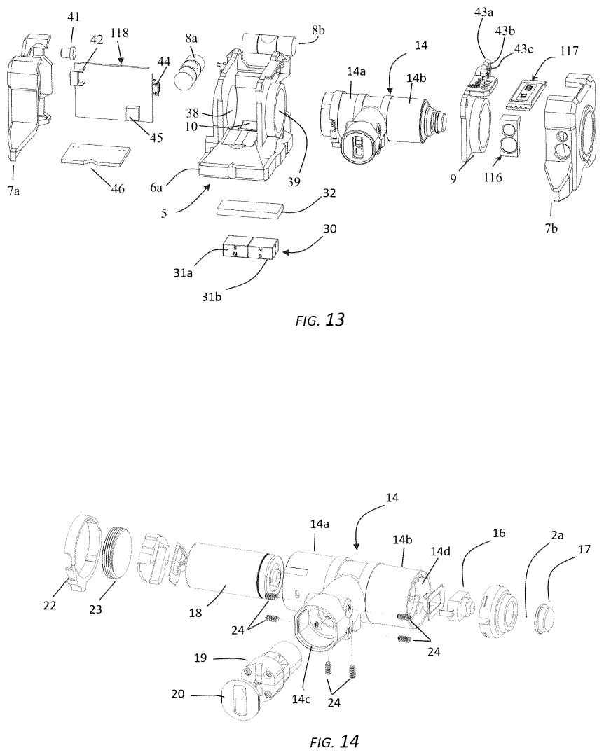

Turning to FIG. 13, an exploded view of a preferred embodiment of the present invention is shown having a main housing assembly (5) that consists of a main chassis (6a), a bubble level (8a) mounted in a direction generally parallel to the laser line plane, a bubble level (8b) generally mounted in a direction perpendicular to the laser line plane, a pivoting laser module pivot surface (38) that constrains the pivoting laser module (14) surface (14a), and a frictional braking device (10) that provides rotational resistance to the pivoting laser module (14) to allow the pivoting laser module (14) to stay in a set position once adjusted. A bracket (9) is shown that has an axle surface (39) that constrains the pivoting laser module assembly (14) by providing a bearing surface (39) to constrain the pivoting laser module surface (14b). An electronic system is shown consisting of a capacitive edge finding sensor (46), a main control board (118) that processes and outputs all sensor information, a battery charging port (44), a live electrical wire sensor (45), an edge finder activation and calibration button (41) that activates the edge finder activation and calibration switch (42) and three LED indicator lights (43a), (43b) and (43c). A right-hand side cover (7a) and left-hand side cover (7b) are shown to provide generally cosmetic, water proofing and dust proofing protection for the electronic components. A pair of dipole magnets form a compound pair of magnets (30) consisting of dipole magnet (31a) that has the north and south poles flipped versus the adjacent dipole magnet (31b) forming an attractive arrangement between the magnets and creating an intense magnetic field center region between the two magnets. A metallic backing plate (32) is attached to the upper side of the compound pair of magnets (30) and directs the magnetic field shape of the magnets to protrude deeper into a wall and provides shielding of the magnetic field from protruding upwards towards the laser diode. The metallic backing plate (32) provides a much stronger magnetic holding strength of the magnet assembly (30) to a drywall screw or other metallic object located in a wall versus the alternative of using very thick magnets to produce the same depth of magnetic field and weigh much more. An optical distance sensor (116) is shown and a digital display (117).

With reference to FIG. 14, a pivoting laser module (14) is shown containing the rechargeable battery (18) that fits into the battery chamber (14d), the cross line laser diode (19) mounted within a barrel section (14c) of the cross pivoting laser module (14), the laser activation button (17) that presses the laser activation toggle switch (16) and provides two cylindrical surfaces (14a) and (14b) that rotate on axis (2a) through a range of motion.

FIG. 15 shows a top view of a preferred embodiment of the present invention as held by a user. For a right-handed person, the person pinches the device between the right-hand thumb (50) and right-hand forefinger (51) with the right-hand thumber pressing the laser activation switch button (17). The lower bubble level (8a) can be oriented with the bubble between the lines indicating that a plumb laser line can then be projected. Alternatively, the unit could be oriented at a position 90 degrees relative to the orientation shown in the figure wherein bubble level (8b) could be used to aid in projecting a horizontal line on the surface that the device is attached to. In the orientation shown, the cross laser can project fixed plumb laser line with an adjustable elevation laser line on an opposing parallel wall. If the device were rotated 90 degrees from the orientation, the cross laser could project a fixed elevation laser line with an adjustable plumb laser line on an opposing parallel wall. With the left and thumb (50) applying force directly through the pivoting laser module pivot axis towards the forefinger (51), there is no moment applied to the device and the device will remain stationary. This is convenient if the device has already been adjusted.

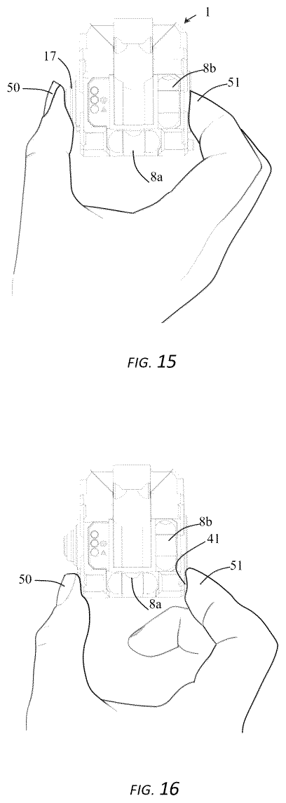

FIG. 16 also shows a top view of a preferred embodiment of the present invention as held by a user, in this instance while the user is activating the electronic edge finding system with forefinger (51) pressing button (41) and squeezing the device with the thumb (50) to maintain control of the device (1). The bubble levels (8b) and (8a) may be used to orient the device in a plumb or level orientation depending on the desired goal.

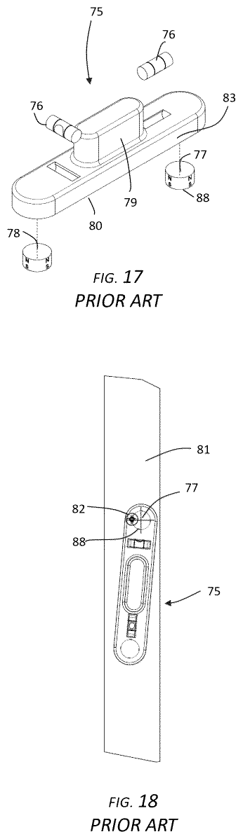

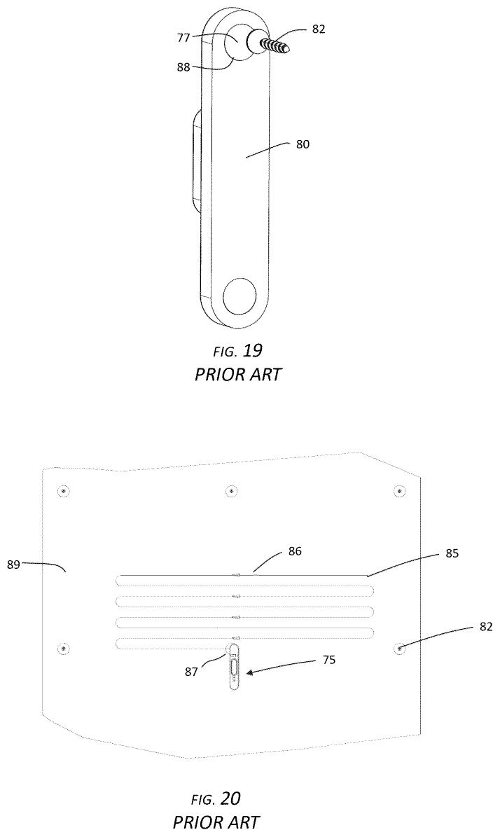

FIGS. 17 through 19 illustrate a certain prior art embodiment wherein a magnetic stud finder assembly (75) with two cylindrical shaped bipolar magnets (77) and (78), a main housing (83) with a holding area (79) and bubble levels (76) mounted in a perpendicular arrangement. As shown in FIG. 18, this prior art embodiment may be magnetically attached by the magnet (77) to a drywall screw (82) screwed into the wall stud (81). Since the strongest magnetic field strength of the magnet (77) is located around the perimeter edge (88), the stud finder (75) could attach itself the center of the head of screw (82) at any point around the perimeter (88) and the stud finder assembly (75) could hang and pivot from that attachment point causing the stud finder assembly (75) to hang at a slight angle to the stud and to also predict an incorrect location of the center of the screw (82) and give an inaccurate estimate of the center of the stud (81). As shown in FIG. 19, the contact surface (80) has magnet (77) that is attracted to a screw center at a point around the magnet's perimeter (88). The screw (82) could attach to the magnet (77) at any point around the edge (88) since the magnetic field strength is strongest around this perimeter of the dipole magnet, which is undesirable.

FIG. 20 illustrates a usage case for the prior art embodiment shown in the immediately preceding figures. Here, a wallboard (89) is attached to a studs using a series of drywall screws (82). The prior art device is held at starting at point (85) and then is swept back and forth along a path (86) to scan for a magnetic attraction between the stud finder (75) magnet and the screw (87) located at a point along the path. This sweeping motion is time consuming since the diameters of the magnets are typically between ¼″ and ½″ and the magnets must pass directly over a screw to locate it.

As shown in FIGS. 21a and 22, a pair of bipolar bar magnets (30) magnetized through their thickness are attached magnetically to one another with the magnetic poles flipped as shown along a side surface. In this arrangement, the magnets form a compound pair of magnets which produces a very strong magnetic force located in the center region (47) as shown by the magnetic field lines (38) that are generally orthogonal to the magnetic force directions. A metal backing plate (32) is attached to one side of the compound pair of magnets, further enhancing the magnetic field strength in the center region (47) in the direction of the screw (40). A similar magnetic strength could be achieved with thicker magnets instead of using the metallic plate (32), however, the weight and cost of the thicker magnetic assembly would be significantly higher, and the thicker magnet weight would be detrimental to the design of the stud finder since it is held to the wall with magnetic attractive force to the drywall screw and with the friction between the wall and the stud finder.

As shown in FIG. 21b, multiple bipolar magnets (30b) are arranged in a column having two pairs bipolar bar magnets (31c) and (31d) magnetized through their thickness and attached magnetically to one another with the magnetic poles flipped as shown along a side surface. In this arrangement, the stacked compound pair of magnets (31c) and (31d) forms columnar compound pairs of compound magnets which produce a very strong magnetic force located in the center region (47b) as shown by the magnetic field lines (38b) that are generally orthogonal to the magnetic force directions. A metal backing plate (32) is attached to one side of the stacked compound pair of magnets, further enhancing the magnetic field strength in the center region (47b) in the direction of the screw (40).

As shown in FIG. 22 (with details shown in FIG. 23), the magnetic assembly (30) may be installed into the lower surface of device assembly (1). Screw (40) is shown located at the highest magnetic field location in the middle surface (47) between magnets (31a) and (31b). The device (1) will naturally rotate about the screw axis (3a) 360 degrees in the direction of (3b) and will remain centered on screw (40) while doing so. This is a significant advantage for the device to be capable of locating the center of the screw (40). This improves the accuracy of locating and marking the center of the stud using the indicator surface notch (28) and to allow for orientating various devices such as a laser or a distance meter in any direction while pivoting about the centerline of the screw (40).

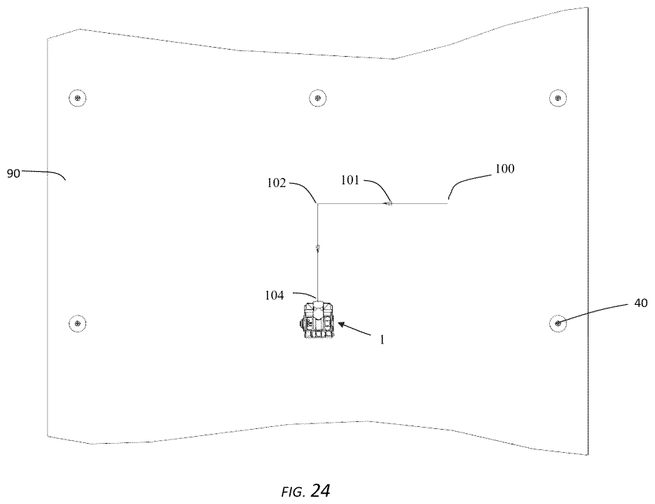

FIG. 24 illustrates a method of use of a preferred embodiment of the present invention. Here, a wallboard (90) attached to studs using a series of drywall screws (40). The a preferred embodiment of the present invention is moved along path (101) starting at a starting point (100) then laterally until the device detects the edge of the stud at point (102), approximately located in the middle of a stud. Once the stud is detected, the device (1) is moved in a vertical motion until the compound pair of magnets attach to the nearest drywall screw at the final position (104). This is a significant improvement to confirm electronic detection of a stud by immediately attaching the device to a magnetically detect a screw for confirmation. It is also a significant improvement over a magnetic drywall screw finder by significantly reducing the time needed to locate a drywall screw.

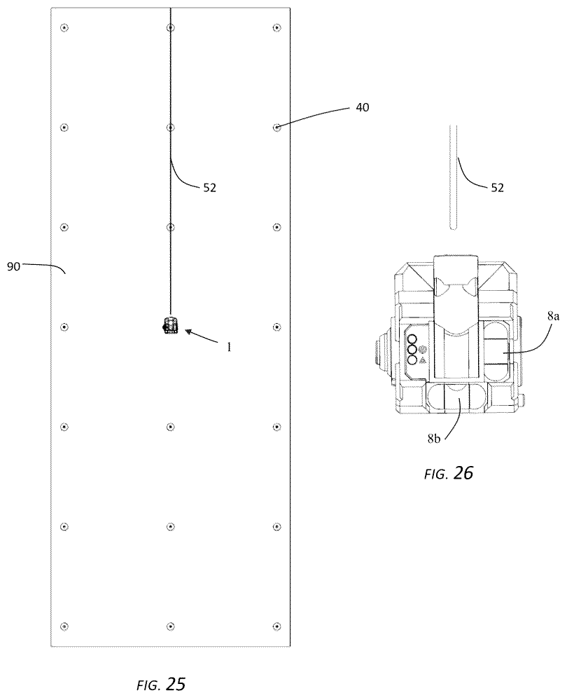

Turning to FIG. 25, there is shown a preferred embodiment of the present invention magnetically mounted to a drywall screw (40) within the wall board (90) and projecting a vertical plumb laser line (52) marking the centerline of a stud. In this view, the pivoting laser module barrel is oriented in the down position. In this use case, the stud finder device (1) can remain on the wall magnetically attached to the drywall screw while construction activities are completed on the wall, as shown in FIG. 26, wherein bubble level (8b) is indicating level and the laser line being projected is a vertical plumb laser line which is typically needed to mark vertical studs.

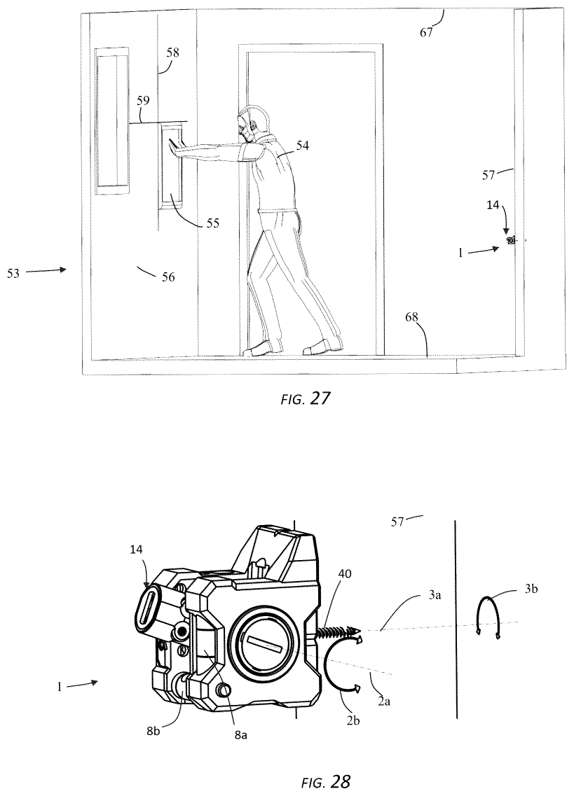

FIG. 27 shows a preferred embodiment of the present invention in use in a typical room (53) where person (54) is positioning a picture (55) onto a wall (56). The person (54) is aligning the top edge of the picture (55) to the horizontal elevation laser line (58) and a side edge of the picture (55) to a vertical plumb laser line (58). The laser lines (58) and (59) are being projected by the adjustable pivoting laser module (14) mounted in assembly (1). In this setup, the elevation laser line (59) can be adjusted upwards or downwards on the wall (56) and the vertical plumb laser line (58) will remain in the same lateral position when the pivoting laser module is adjusted upwards or downwards. Wall (57) is parallel to wall (53). In this use case, a tripod is not needed to project a plumb laser line (58) or an elevation laser line (59) to hang the picture. If the pivoting laser module (14) is rotated further upwards in this configuration, the plumb laser line (58) and the elevation laser line (59) can also be projected onto the ceiling since the ceiling is perpendicular to wall (57). If it is desired to project the plumb laser line (58) or the elevation laser line (59) onto the floor surface, there may not be enough range of motion allowed on the pivoting laser module (14), however, the device (1) can be rotated 180 degrees on the wall and will pivot on the axis of the drywall screw for the laser to become pointed at the floor surface.

With FIG. 27 in mind, FIG. 28 illustrates the device (1) mounted to the wall (57) with the compound pair of magnets attached to the drywall screw (40). The bubble level (8b) indicates a level condition, with the bubble position between the lines, which will produce a vertical plumb laser line and a horizontal elevation laser line on the opposing surface. The pivoting laser module (14) is pivoted upwards to set the height of the elevation laser line on the opposing surface. The pivoting laser module (14) can be pivoted about the axis (2a) in a range of motion (2b). The device (1) can be rotated 360 degrees on the wall about axis (3a) through a range of motion (3b). In the orientation shown in FIG. 28, the elevation laser line projected onto the opposing wall is adjustable upwards or downwards, and the plumb laser line on the opposing wall is not adjustable. If the device (1) is rotated 90 degrees about axis (3a), the pivoting laser module (14) can be pivoted on axis (2a) to adjust the vertical plumb laser line on the opposing surfaces thereby sweeping the plumb line around the room and the elevation laser line will not be vertically adjustable in this position. In this rotated orientation, the bubble level (8a) will be the level that is used to position the device.

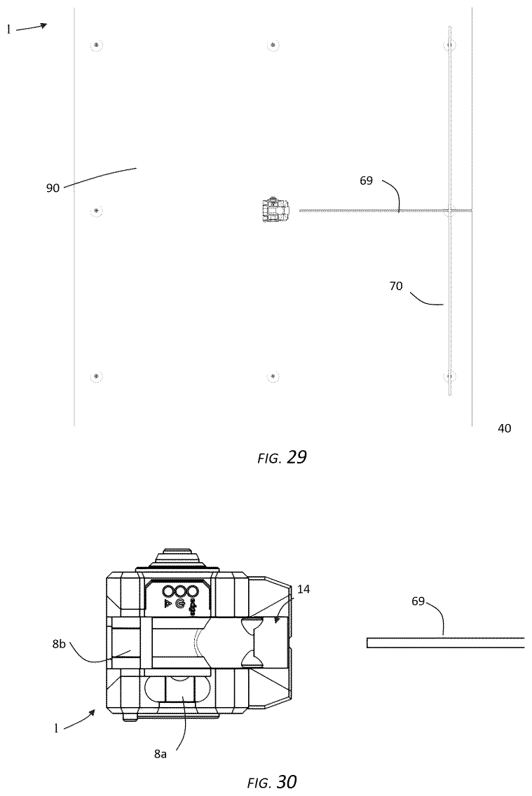

FIG. 29 illustrates another use case for preferred embodiments of the present invention wherein the device is mounted to a wall surface (90) magnetically attached to a drywall screw (40) and oriented in a horizontal position with the pivoting laser module oriented in the down position against the lower housing stop. In this configuration, the cross laser will project a horizontal laser line (69) and a vertical plumb laser line (70) that marks the neighboring stud at a distance such as 16 inches without the need for a tape measure or other measuring device.

FIG. 30 provides a detailed view of the preceding use case, showing the bubble level (8a) indicating a horizontal position with laser line (69) projected horizontally. The device could be oriented at any position and project the offset line at the indicated distance if the pivoting laser module assembly (14) is adjusted to touch the lower housing stop.

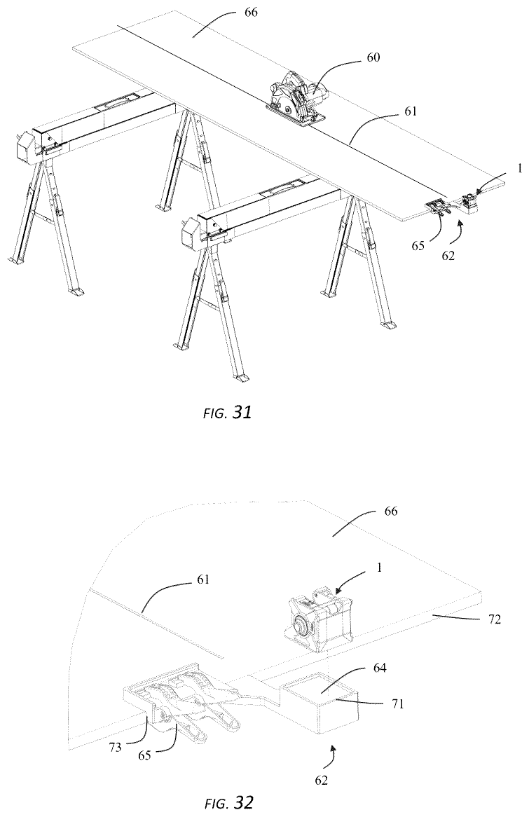

Yet another use for preferred embodiments of the present invention case is illustrated in FIGS. 31 and 32. Here, a panel such as a sheet of plywood or drywall (66) is being cut by circular saw or other cutting device. A preferred embodiment of the present invention is mounted in an attachment or square device (62). The panel cutting attachment (62) is attached to the workpiece with several clamps (65) that hold the panel cutting assembly to the workpiece (66) while the cutting device (60) is used to make the cut. The panel (66) has laser line (61) projected by the stud finding device (1) that is magnetically attached to surface (64) and aligned by the four edges (71) that aligned the device to the panel cutter attachment (62). The panel cutter attachment is attached to the workpiece (66) by several clamps (65) and is aligned to the workpiece edge (72) by the mechanical stop (73) that is built into the panel cutting device (62).

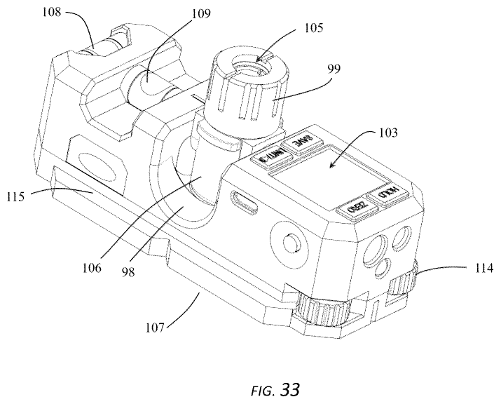

FIG. 33 shows a different preferred embodiment of the present invention having an electronic distance finder (33), a pivoting laser module (105) with a perpendicular mechanical stop device (106), a magnetic mount base (107), a bubble level (108) mounted in a perpendicular orientation to the pivoting axis of the pivoting laser module (105) and a bubble level (109) mounted in a parallel direction to the pivoting axis of the pivoting laser module (105). Three adjustment screws (114) form a tripod arrangement to adjust the device to be level with a surface that the device is sitting on. A mechanical stop surface (98) is shown to limit the motion of the pivoting laser module (105) to produce a laser line that is offset at a specified distance such as 16 inches for a neighboring stud. A rotating cap (99) may be utilized to mount a line or cross laser diode and adjust the laser in an angular movement relative to the laser beam centerline.

Although the particular embodiments shown and described above will prove to be useful in many applications in the art to which the present invention pertains, further modifications of the present invention will occur to persons skilled in the art. All such modifications are deemed to be within the scope and spirit of the present invention as defined by the appended claims.

1. A device comprising:
a. a housing having top, bottom, and side walls, the bottom wall having a substantially planar bottom surface;
b. two dipole magnets forming a compound pair of magnets disposed in the bottom surface;
c. a barrel having a proximal end and a distal end, the barrel pivotally mounted near its proximal end to the device housing for pivotal movement in relation to the housing; and
d. a laser disposed within the barrel, the laser creating, when activated, a laser beam projecting through the distal end of the barrel.

2. The device of claim 1 further comprising a stop disposed in the device housing positioned to stop the pivoting of the barrel at a predefined position such that when activated, the laser beam intersects a plane defined by the planar bottom surface.

3. The device of claim 2 wherein the laser beam intersects the plane defined by the planar bottom surface at a predetermined distance from the housing.

4. The device of claim 3 wherein the predetermined distance is between 15 and 17 inches.

5. The device as in any of claims 1-4 wherein the laser beam is selected from the group consisting of a cross beam, a line beam, and a dot beam.

6. The device as in any of claims 1-4 further comprising a first bubble level secured to the housing, the first bubble level having a centerline parallel the bottom housing surface and parallel to one of the housing side walls.

7. The device of claim 6 further comprising a second bubble level secured to the housing orthogonally to the first bubble level.

8. The device of claim 6 wherein the laser beam is selected from the group consisting of a cross beam, a line beam, and a dot beam.

9. The device of claim 7 wherein the laser beam is selected from the group consisting of a cross beam, a line beam, and a dot beam.

10. A device comprising:
a. a housing having top, bottom, and side walls, the bottom wall having a substantially planar bottom surface;
b. two dipole magnets forming a compound pair of magnets disposed in the bottom surface;
c. a barrel having a proximal end and a distal end, the barrel pivotally mounted near its proximal end to the device housing for pivotal movement in relation to the housing;
d. a laser disposed within the barrel, the laser creating, when activated, a laser beam projecting through the distal end of the barrel;
e. a sensor disposed in the device housing; and
f. a circuit operatively connected to the sensor for processing an output of the sensor.

11. The device of claim 10 where the sensor is a differential capacitive stud sensor.

12. The device of claim 10 where the sensor is a live electrical wire sensor.

13. The device of claim 10 where the sensor is an electronic distance sensor.

14. The device of claim 10 where the sensor is an accelerometer with at least one sensing axis.

15. The device of claim 10 further comprising a digital display disposed in the housing and operatively connected to the circuit for displaying the output of the sensor as processed by the circuit.

16. The device as in any of claims 10-15 wherein the laser beam is selected from the group consisting of a cross beam, a line beam, and a dot beam.

17. The device as in any of claims 10-15 further comprising a first bubble level secured to the housing, the first bubble level having a centerline parallel the bottom housing surface and parallel to one of the housing side walls.

18. The device of claim 17 further comprising a second bubble level secured to the housing orthogonally to the first bubble level.

19. The device of claim 10 further comprising a stop disposed in the device housing positioned to stop the pivoting of the barrel at a predefined position such that when activated, the laser beam intersects a plane defined by the planar bottom surface.

20. The device of claim 19 wherein the laser beam intersects the plane defined by the planar bottom surface at a predetermined distance from the housing.

21. The device of claim 20 where in the predetermined distance is between 15 and 17 inches.

22. The device as in any of claims 19-21 wherein the laser beam is selected from the group consisting of a cross beam, a line beam, and a dot beam.

23. The device as in any of 1-4 or 10-15 or 19-21 further comprising a metal plate disposed at a side the compound pair of magnets opposite the bottom surface.

24. A device comprising:
a. a housing having top, bottom, and side walls, the bottom wall having a substantially planar bottom surface; and
b. a pair of dipole magnets forming a compound pair of magnets, the compound pair of magnets having a first side disposed in the bottom surface and a second side opposite the first side.

25. The device of claim 24 further comprising a metal plate disposed at the second side of the compound pair of magnets.

26. A device comprising:
a. a housing having top, bottom, and side walls, the bottom wall having a substantially planar bottom surface.
b. a pair of dipole magnets forming a compound pair of magnets, the compound pair of magnets having a first side disposed in the bottom surface and a second side opposite the first side.
c. a sensor disposed in the device housing; and
d. a circuit operatively connected to the sensor for processing an output of the sensor.

27. The device of claim 26 where the sensor is a differential capacitive stud sensor.

28. The device of claim 26 where the sensor is a live electrical wire sensor.

29. The device of claim 26 where the sensor is an electronic distance sensor.

30. The device of claim 26 where the sensor is an accelerometer that may be capable of inclination sensing on one or more axis.

31. The device of claim 26 with a digital display disposed in the housing.

32. The device as in any of claims 26-31 further comprising: A first bubble level secured to the housing, the first bubble level having a centerline parallel the bottom housing surface and parallel to one of the housing side walls.

33. The device of claim 32 further comprising a second bubble level secured to the housing orthogonally to the first bubble level.

34. The device as in any of claims 26-31 wherein a metal plate is disposed at the second side of the compound pair of magnets.

35. The device of claim 34 further comprising a first bubble level secured to the housing, the first bubble level having a centerline parallel the bottom housing surface and parallel to one of the housing side walls.

36. The device of claim 35 further comprising a second bubble level secured to the housing orthogonally to the first bubble level.

37. A device comprising:
a. a housing having top, bottom, and side walls, the bottom wall having a substantially planar bottom surface.
b. one or more dipole magnets disposed in the bottom surface;
c. a sensor disposed in the device housing; and
d. a circuit operatively connected to the sensor for processing an output of the sensor.

38. The device of claim 37 where the sensor is a differential capacitive stud sensor.

39. The device of claim 37 where the sensor is a live electrical wire sensor.

40. The device of claim 37 further comprising a digital display disposed in the housing and operatively connected to the circuit for displaying the output of the sensor as processed by the circuit.

41. The device as in any of claims 37-40 further comprising a first bubble level secured to the housing, the first bubble level having a centerline parallel the bottom housing surface and parallel to one of the housing side walls.

42. The device of claim 41 further comprising a second bubble level secured to the housing orthogonally to the first bubble level.

43. A device comprising:
a. a housing having top, bottom, and side walls, the bottom wall having a substantially planar bottom surface;
b. one or more dipole magnets disposed in the bottom surface;
c. a barrel having a proximal end and a distal end, the barrel pivotally mounted near its proximal end to the device housing for pivotal movement in relation to the housing; and
d. a laser disposed within the barrel, the laser creating, when activated, a laser beam projecting through the distal end of the barrel.

44. The device of claim 43 further comprising a stop disposed in the device housing positioned to stop the pivoting of the barrel at a predefined position such that when activated, the laser beam intersects a plane defined by the planar bottom surface.

45. The device of claim 44 wherein the laser beam intersects the plane defined by the planar bottom surface at a predetermined distance from the housing.

46. The device of claim 45 where in the predetermined distance is between 15 and 17 inches.

47. The device as in any of claims 43-46 wherein the laser beam is selected from the group consisting of a cross beam, a line beam, and a dot beam.

48. The device as in any of claims 43-46 further comprising a first bubble level secured to the housing, the first bubble level having a centerline parallel the bottom housing surface and parallel to one of the housing side walls.

49. The device of claim 48 further comprising a second bubble level secured to the housing orthogonally to the first bubble level.

50. The device as in any of claim 1, 10, 24, 37, or 43 further comprising a marking surface disposed on the housing, the marking surface having one or with one or more marking guides located a predetermined distance from the center of the compound pair of magnets.

51. The device of claim 50 wherein the predetermined distance is between 0.74 inches and 0.76 inches from the center of the compound pair of magnets.

52. The device of claim 50 wherein the predetermined distance is between 1.4 inches and 1.6 inches from the center of the compound pair of magnets.
